(19) United States
(12) Patent Application Publication
(10) Pub. No.: US 2011/0072727 A1
(43) Pub. Date: Mar. 31, 2011

(54) AUTOMATIC OPENING/CLOSING DEVICE OF OPENING/CLOSING MEMBER AND OPENED/CLOSED MEMBER USING THE SAME

(76) Inventor: KEIZO KUMAZAWA, Kanagawa (JP)

(21) Appl. No.: 12/886,720

(22) Filed: Sep. 21, 2010

(30) Foreign Application Priority Data
Sep. 25, 2009 (JP) 2009-221571

(51) Int. Cl. E05F 15/00; E05F 1/00; E05F 1/10; E05F 3/20

(52) U.S. Cl. 49/358; 16/71; 16/72; 16/50

(57) ABSTRACT

In automatically opening and closing an opening/closing member with regard to an opened/closed member via a hinge, a drive for this purpose mechanically independent from the opened/closed member is mounted on a side of the opening/closing member and so designed that it rotates together with the opening/closing member when it opens and closes; where the opened/closed member is in particular a main body of office equipment and the opening/closing member an original cover, and the hinge comprises at least a mounting member mounted on a side of the main body and a supporting member of original cover rotatably mounted on the mounting member. The drive mechanically independent from the main body is mounted on a side of the original cover and so designed that it rotates together with the original cover when it opens and closes.

### FIELD OF THE INVENTION

The present invention relates to an automatic opening/closing device of an opening/closing member, suitable in use for automatically opening/closing an opening/closing member, in particular an original cover of an office equipment, as well as to an opened/closed member using the automatic opening/closing device, in particular an office equipment.

### BACKGROUND ART

In a copying machine, in particular large one, as a sort of office equipment being opened/closed member, an opening/closing device of a heavy opening/closing member weighing some 20-30 kg, in particular an original cover (mostly equipped with automatic original feeder) is provided; among such opening/closing devices of opening/closing members, an automatic opening/closing device of original cover is desirable, wherein the device enables an original cover to automatically open and close, for improving its operability in response to the weight of original cover and for facilitating operations by an operator in wheelchair, which is not necessarily the case of a heavy original cover. Among automatic opening/closing devices of original covers as above described, the ones disclosed in JP Laid-Open Patent Publications No. 2009-122141 and 2009-036994 are publicly known.

An automatic opening/closing device of original cover disclosed in JP Laid-Open Patent Publication No. 2009-122141 mentioned above comprises a drive means including a drive motor being a power source, wherein the drive means is mounted on the main body side, and an power output generated by the drive means is transmitted to a drive shaft also functioning as a hinge pin of a supporting member for supporting the original cover with regard to a mounting member, so that the original cover is opened and closed via the supporting member which rotates.

The automatic opening/closing device of original cover assembled in this manner is not desirable in terms of appearance since the drive means still protrudes on the main body side when the original cover is opened, and the automatic opening/closing device further necessitates design changes on a main body. Therefore, it is not so widespread. In recent years, specialization is advanced for copying machine, and separate specialized manufacturers produce main body, original cover with automatic original feeder and opening/closing device of original cover for opening/closing original cover with regard to main body respectively; first, a manufacturer of original cover mounts opening/closing devices of original cover on the original covers, and then the one for copying machine purchases original covers with opening/closing devices and assembles them to main bodies.

Therefore, an automatic opening/closing device of original cover is developed, wherein a drive means mechanically independent from a main body is mounted on a mounting member of a hinge means, as disclosed in JP Laid-Open Patent Publication No. 2009-036994. The automatic opening/closing device of this sort has an advantage in that it does not impose design changes on the main body in installing the drive means. However, even this opening/closing device has not resolved the problem of undesirable appearance yet, since the drive means remains exposed on the main body when the original cover is opened.

Moreover, there is also problem in that maintenance requires additional steps and is thus complicated, since the drive means together with the hinge means should be removed from the main body, when the original cover needs to be removed from the main body for repair and inspection.

### SUMMARY OF THE INVENTION

The present invention considers the above-mentioned points. It is an object of the invention to provide an automatic opening/closing device of opening/closing member, wherein it is only necessary to negotiate with a design section of manufacturer of original cover when an automatic opening/closing device of original cover being opening/closing member is adopted, a drive means is not exposed so as to protrude on a main body (opened/closed member) when the original cover (opening/closing member) is opened, and a removal of the original cover during maintenance is facilitated.

In order to achieve the above-mentioned tasks, the present invention solves the above-mentioned problems by the following means:

First, an invention according to claim 1 is characterized in that an opening/closing member is rotated via a hinge means with regard to an opened/closed member for automatically opening/closing the opening/closing member, and that for this purpose a drive means mechanically independent from the opened/closed member is mounted on the side of the opening/closing member and so designed that it rotates together with the opening/closing member when the opening/closing member opens and closes.

Next, an invention according to claim 2 is characterized in that the opened/closed member is a main body of an office equipment and the opening/closing member is an original cover, and that for this purpose the hinge means comprises at least a mounting member mounted on the side of the main body and a supporting member of the original cover rotatably mounted on the mounting member, and the drive means mechanically independent from the opened/closed member is mounted on the side of the opening/closing member and so designed that it rotates together with the original cover, when the opening/closing member opens and closes.

Next, an invention according to claim 3 is characterized in that the hinge means comprises at least the mounting member mounted on the side of the main body and the supporting member of the original cover rotatably mounted on the mounting member, a lift member mounted on a free end side of the supporting member so as to be rotatable in a direction contrary to the supporting member and a first rotation control means allowing for a rotation of the lift member, exclusively when a predetermined rotation torque is applied.

Next, an invention according to claim 4 is characterized in that the hinge means comprises at least the mounting member mounted on the side of the main body and the supporting member of the original cover rotatably mounted on the mounting member, the lift member mounted on a free end side of the supporting member so as to be rotatable in a direction contrary to the supporting member and a second rotation control means urging the supporting member in the opening direction of the original cover between the mounting member and the supporting member.

Next, an invention according to claim 5 is characterized in that the hinge means comprises at least the mounting member mounted on the side of the main body and the supporting member of the original cover rotatably mounted on the mounting member, the lift member mounted on the free end side of the supporting member so as to be rotatable in a direction contrary to the supporting member and the rotation restricting means allowing for the rotation of the lift member, exclusively when the predetermined rotation torque is applied.

Further, an invention according to claim 6 is characterized in that the first rotation control means is a resilient means resiliently provided between the side of the mounting member and an actuating member provided at a position different from a pivotally supported position of the lift member with regard to the supporting member.

Still further, an invention according to claim 7 is characterized in that the first rotation control means is a resilient means resiliently provided between the lift member and the supporting member.

In addition, an invention according to claim 8 is characterized in that the second rotation control means is a resilient means resiliently provided between the side of the mounting member and a free end side of the supporting member.

Moreover, an invention according to claim 9 is characterized in that the second rotation control means is a resilient means resiliently provided between the side of the mounting member and the actuating member provided at the position different from the pivotally supported position of the lift member with regard to the supporting member.

Moreover, an invention according to claim 10 is characterized in that the second rotation control means is equipped with a fluid damper means operating at the predetermined closing angle.

Next, an invention according to claim 11 is characterized in that the rotation control means comprises a locking member rotatably mounted on the supporting member and the mounting member, an engagement pin mounted on a side of the lift member so as to be engaged with the locking member and a resilient means rotatably urging the locking member in one direction.

Next, an invention according to claim 12 is characterized in that the drive means is mounted on the supporting member and so designed that it rotates together with the supporting member.

Next, an invention according to claim 13 is characterized in that the drive means is mounted on the original cover and so designed that it rotates together with the original cover.

Next, an invention according to claim 14 is characterized in that the drive means is equipped with an electromagnetic clutch means.

Next, an invention according to claim 15 is characterized in that the drive means applies a rotation drive force to a hinge pin same as a drive shaft which pivotally supports the supporting member on the mounting member so as to be rotatable.

Next, an invention according to claim 16 is characterized in that the drive means applies a rotation drive force to a free end side of the supporting member.

Next, an invention according to claim 17 is characterized in that the drive means uses a plurality of endless belts.

Next, an invention according to claim 18 is characterized in that the drive means comprises distortion detecting means mounted on a drive shaft and a main shaft connected with the hinge means.

Next, an invention according to claim 19 is an opened/closed member characterized in that it is equipped with an automatic opening/closing device according to each aspect of the above-mentioned invention.

Then, an invention according to claim 20 is an office equipment as a sort of opened/closed member characterized in that it is equipped with an automatic opening/closing device according to each aspect of the above-mentioned invention.

As above described, the drive means is provided on the side of the supporting members(s) of the original cover being the opening/closing member and/or a hinge means in accordance with the invention, so that the invention will be feasible only by negotiations on design with manufacturer of the original cover. Therefore, the invention is advantageous in that complicated operations are eliminated and it is highly feasible. It is further advantageous in that the drive means does not remain protruding on the main body, that the appearance is slimmed down, and that repair and maintenance of the main body are facilitated in comparison to the device requiring further detachment and attachment of the drive means from the hinge means as is the case of the conventional ones, since the entire drive means can be separated from the main body in removal of the original cover from the main body during repair and maintenance. Moreover, when in the invention an operating point via the drive means is provided on a free end side of the supporting member of the hinge means or a tip side of the drive case, as in an embodiment 1 described hereinafter, it is advantageous in that the drive motor can be downsized and provided at a reduced cost, since rotation torque during opening and closing of the original cover is reduced due to a location of the operating point on a fore side of the hinge means.

### BRIEF DESCRIPTION OF THE DRAWINGS

FIG. 1 is a perspective view showing the state in use of a copying machine in an embodiment of the present invention;

FIG. 2 is a perspective view of an automatic opening/closing device according to the present invention;

FIG. 3 is an enlarged perspective view of a rotation restricting means of a lift member according to the present invention;

FIG. 4 is a perspective view of an automatic opening/closing device according to the present invention, as shown without a drive case of a drive means;

FIG. 5 is a perspective view showing operation of an automatic opening/closing device according to the present invention;

FIG. 6 is an exploded perspective view of an automatic opening/closing device according to the present invention, in particular of an area of a hinge means;

FIG. 7 is a sectional view of an area of a hinge means of an automatic opening/closing device according to the present invention;

FIG. 8 is a sectional view showing operation of an area of a hinge means of an automatic opening/closing device according to the present invention;

FIG. 9 is an enlarged sectional view of an area of a resilient force adjusting means of a hinge means of an automatic opening/closing device according to the present invention;

FIG. 10 is a plan view of an automatic opening/closing device according to the present invention;

FIG. 11 is a right side view of an automatic opening/closing device according to the present invention;

FIG. 12 is a rear view of an automatic opening/closing device according to the present invention;

FIG. 13 is a sectional view of FIG. 11 in line A-A;

FIG. 14 is a sectional view of FIG. 11 in line B-B;

FIG. 15 is a sectional view of FIG. 11 in line C-C;

FIG. 16 shows a main shaft of an automatic opening/closing device according to the present invention, FIG. 16A being an elevation view of the main shaft and FIG. 16B a perspective view thereof;

FIG. 17 is a perspective view of a drive shaft of an automatic opening/closing device according to the present invention;

FIG. 18 is a vertical sectional view of a clutch pulley of a drive means of an automatic opening/closing device according to the present invention;

FIG. 19 is a perspective view of a first locking member of a rotation restricting means of a lift member of an automatic opening/closing device according to the present invention;

FIG. 20 shows a second locking member of a rotation restricting means of a lift member of an automatic opening/closing device according to the present invention, FIG. 20A being a perspective view as viewed from one side, and FIG. 20B a perspective view as viewed from other side;

FIG. 21 illustrates operation of an automatic opening/closing device according to the present invention, FIG. 21A showing a state prior to starting operation, FIG. 21B a state in the midst of operation and FIG. 21C a state at the end of operation;

FIG. 22 is a perspective view showing other embodiment of an automatic opening/closing device according to the present invention;

FIG. 23 is a perspective view of a state in FIG. 22, but shown without a drive means case of a drive means;

FIG. 24 is a perspective view showing an automatic opening/closing device according to the present invention from other side;

FIG. 25 is a plan view of an automatic opening/closing device according to the present invention;

FIG. 26 is a right side view of an automatic opening/closing device according to the present invention;

FIG. 27 is a rear view of an automatic opening/closing device according to the present invention;

FIG. 28 is a sectional view of FIG. 26 in line A-A;

FIG. 29 is a sectional view of FIG. 26 in line B-B;

FIG. 30 is a sectional view of FIG. 26 in line C-C;

FIG. 31 is an elevation view of a drive shaft of an automatic opening/closing device according to the present invention;

FIG. 32 shows a main shaft of an automatic opening/closing device according to the present invention, FIG. 32A being an elevation view thereof and FIG. 32B a perspective view thereof;

FIG. 33 shows a second locking member of a rotation control means of a lift member of an automatic opening/closing device according to the present invention, FIG. 33A being a side view thereof and FIG. 33B an elevation view thereof;

FIG. 34 illustrates operation of an automatic opening/closing device according to the present invention, as shown without a drive case, FIG. 34A showing a state prior to starting operation, FIG. 34B a state in the midst of operation and FIG. 34C a state at the end of operation;

### EMBODIMENTS OF THE INVENTION

A main body as an opened/closed member implementing the present invention is most preferable when it is a main body for a copying machine among office equipments, however, it is not particularly limited thereto but may be implemented as main body of other office equipments such as printing machine, printer and scanner and other opened/closed members.

Further, an opening/closing member according to the present invention is preferable, when it is large and as heavy as some 20-30 kg, but not limited thereto. It may be implemented as other relatively light one weighing 3-5 kg, and may be further applied in general to an opening/closing member of opened/closed member.

Still further, an automatic opening/closing device implementing the present invention is not limited to an automatic opening/closing device of an original cover with regard to a main body of a copying machine, as illustrated in the following embodiments, but may be implemented to objects in other various publicly known layouts.

Still further, a hinge means is not limited to the ones described in the following embodiments. Basically it works only with the mounting member and the supporting member rotatably mounted on it. Moreover, layouts of a first and a second rotation control means are not limited to the ones in the embodiments. Various publicly known layouts may be used for this purpose.

Additionally, the present invention is implemented to the one on the right of a pair of hinge means on both sides, but not limited thereto and does not hinder from implementing the invention to a hinge means on the left.

In addition, concerning components of a hinge means, although a rotation restricting means of a lift member is useful due to an improved operability if additionally provided, the hinge means does work even without such a means.

Further, although a lift member is useful due to a capacity of working with voluminous original if additionally provided, an original cover may be lifted even without it, e.g. by mounting a mounting member in a one-leg shape into a mounting hole provided on the side of a main body so as to be vertically movable. In this case, the lift member may be omitted. A hinge means according to the present invention includes the one with such a layout.

Embodiments are hereinafter described for the ones related to a drive means separated from a side of a main body and provided on a supporting member side of an original cover and/or a hinge means, wherein the original cover is mounted on the supporting member or a lift member rotatably mounted on the supporting member and a drive case of the drive means is mounted on the hinge means side so as to rotate together with the supporting member. However, another embodiment can be also conceived, wherein the drive case or a case cover is directly mounted on the original cover, without using the supporting member. Moreover, drive cases can be also mounted on both the supporting member and the original cover.

### Embodiment 1

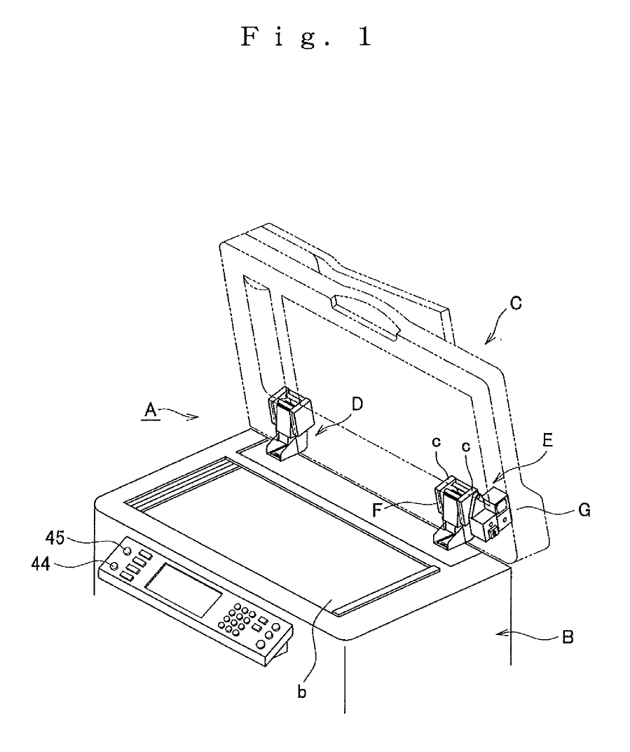

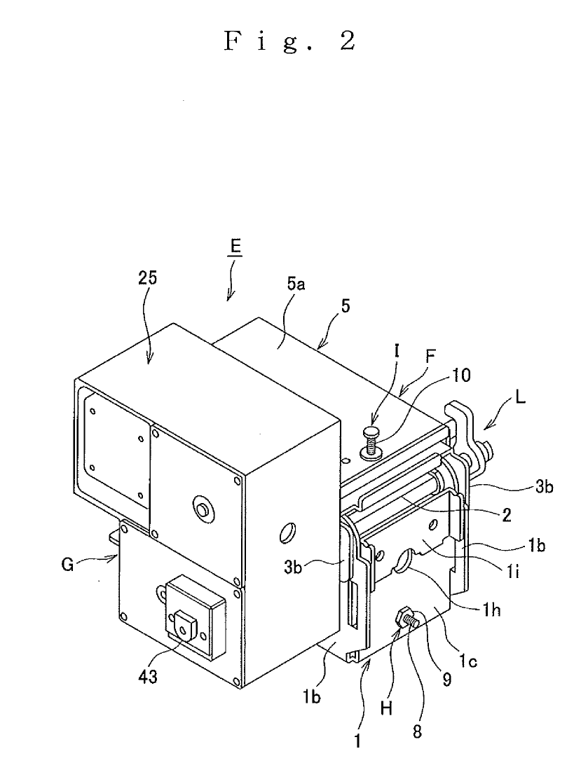

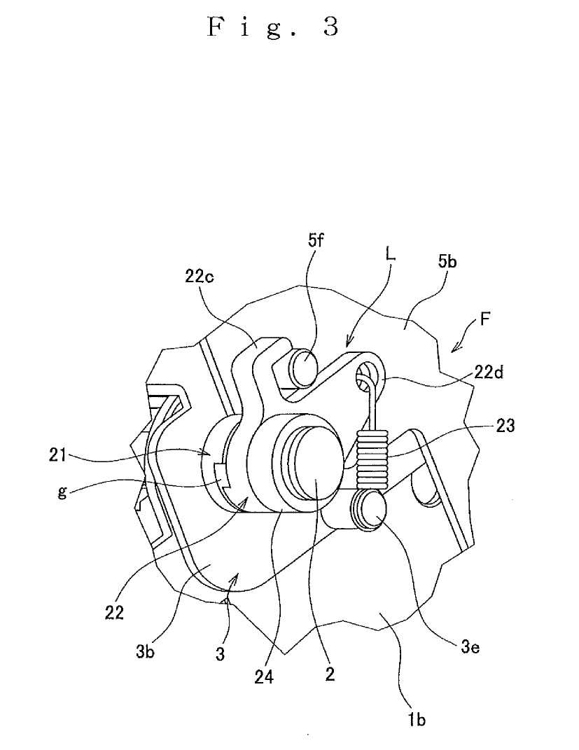

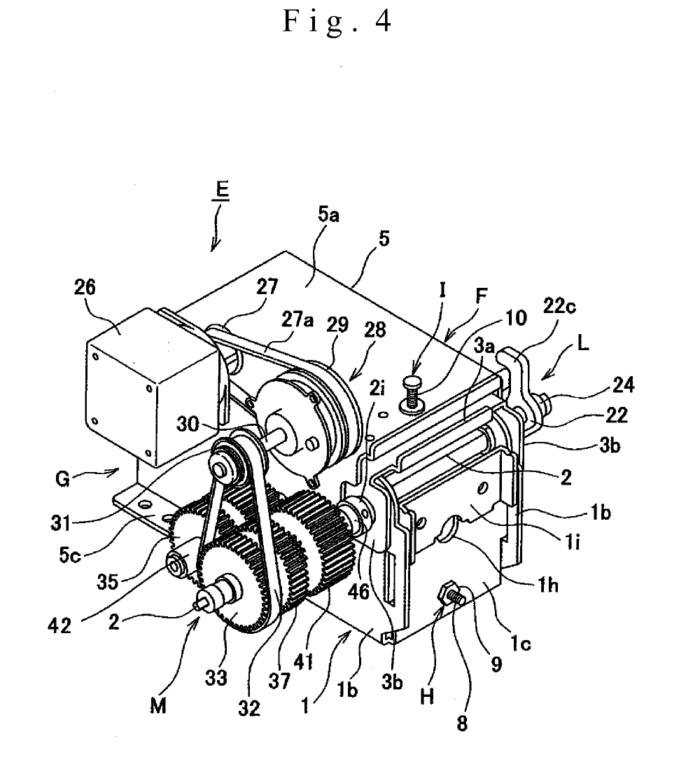

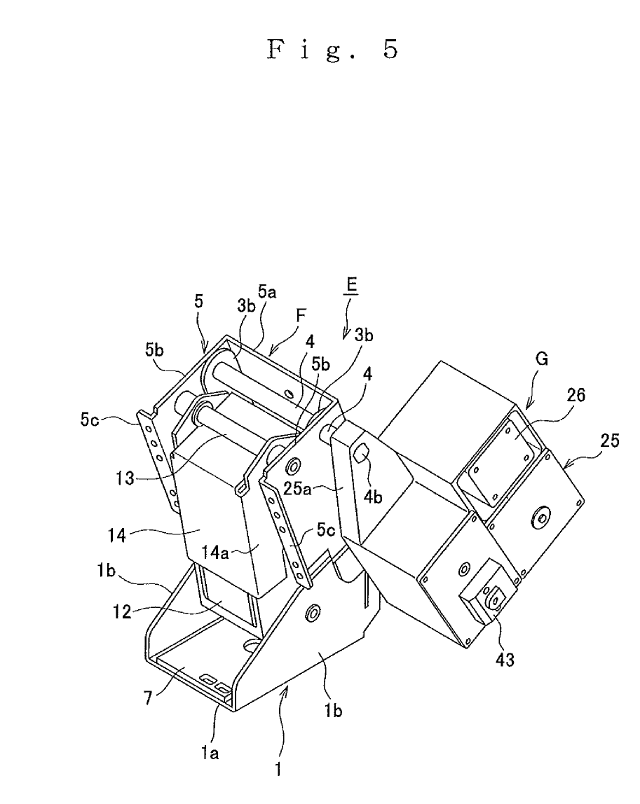

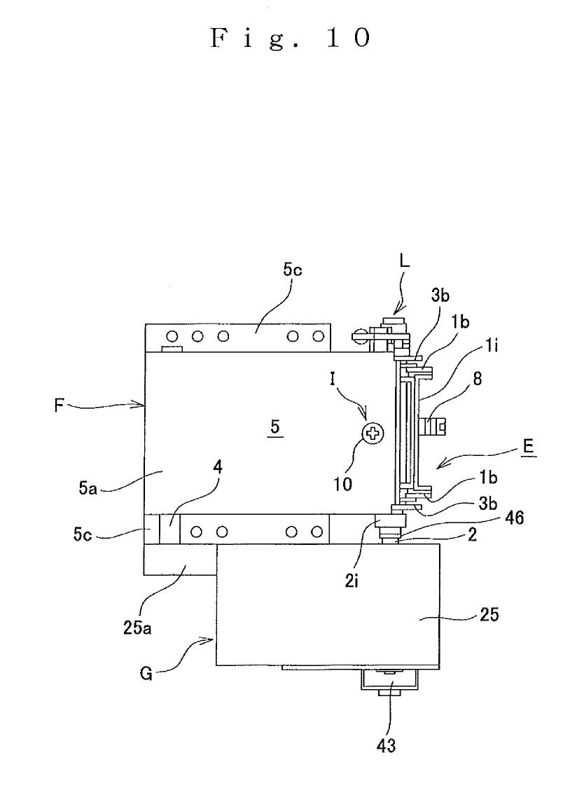

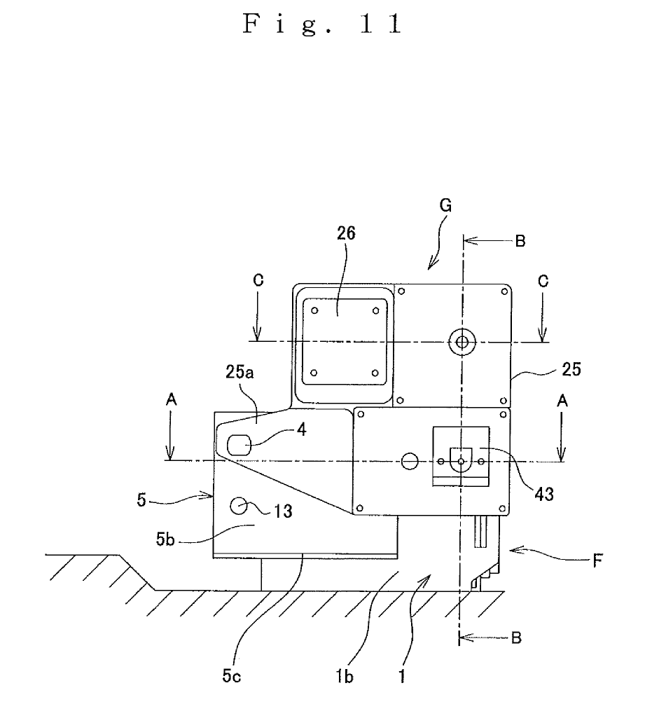

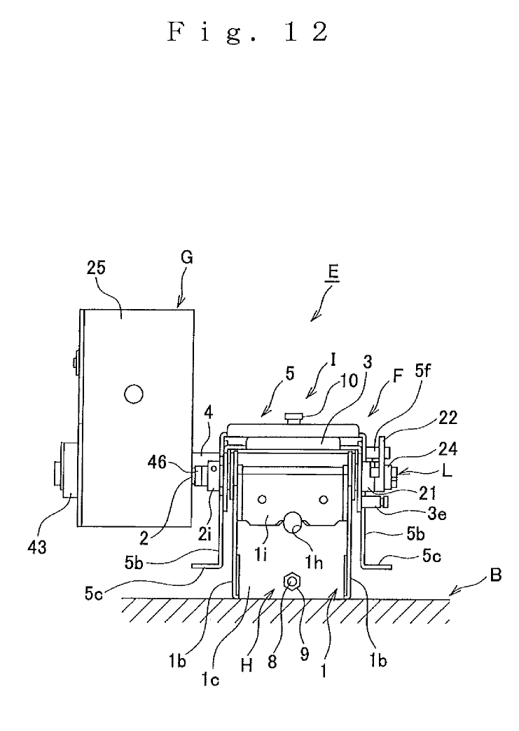

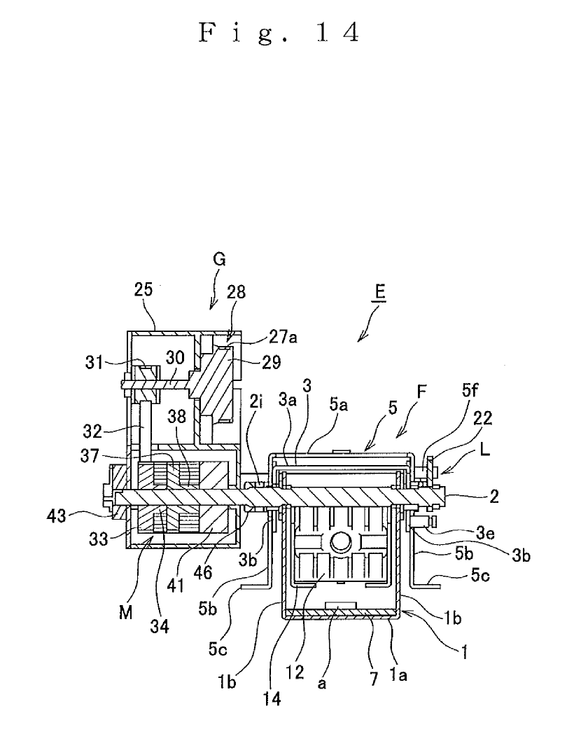

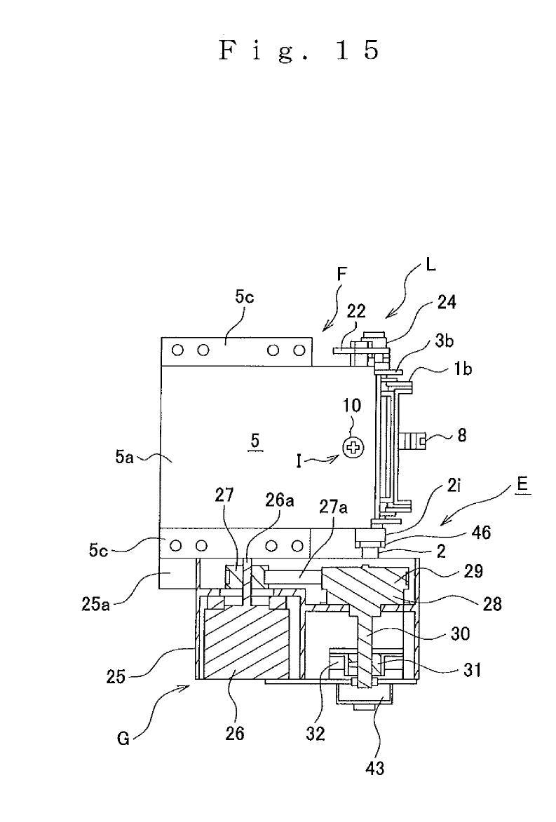

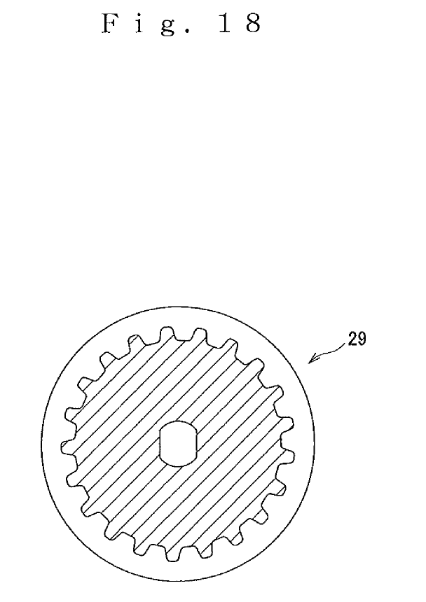

Hereinafter, embodiment 1 of the present invention is described based on the accompanying drawings. In FIGS. 1 to 21, FIG. 1 shows a copying machine, as an example of an office equipment in an embodiment of the present invention. In drawings, reference character A denotes a copying machine which comprises a main body B as an opened/closed member, as well as e.g. an original cover C as an opening/closing member equipped with an automatic original feeder, an opening/closing device D of original cover located on the left if the observer faces the main body B, for openably/closably mounting the original cover C on the main body B, and an automatic opening/closing device E of the original cover (opening/closing member) C according to the present invention located on the right. In the meantime, the automatic opening/closing device E is mounted on the right if the observer faces the main body B of the copying machine A, it may be also mounted on the left, as stated above. However, if the automatic opening/closing device E is mounted on the right of the main body B of the copying machine A, the embodiment is advantageous in that a drive means G can be easily installed even without remarkable change in layout, since the right hand side of the original cover C is not equipped with an automatic original feeder, thus being a so-called open area. On the other hand, if the automatic opening/closing device E is mounted on the left, the embodiment is advantageous in that the arrangement without the device can be maintained in automatically opening and closing the original cover C, since the opening/closing device D of original cover on the left is originally large in order to support the weight of the automatic original feeder installed on the left and the small opening/closing device is mounted on the right.

In the following description, reference will be made to an embodiment wherein an automatic opening/closing device E is installed on the right if the observer faces a main body B of a copying machine A. However, it is not limited thereto, as above stated.

An automatic opening/closing device E of an original cover C according to the present invention is characterized, in particular as shown in FIG. 1, in that a drive means G thereof is provided on a side of the original cover C. In other words, the automatic opening/closing device E according to the present invention comprises a hinge means F and the drive means G thereof, and is characterized in that the drive means G is installed on the side of the original cover C. In the meantime, the one of publicly known layout is used for an opening/closing device D of original cover, therefore detailed illustration and description in this regard are omitted.

A hinge means F of an automatic opening/closing device E according to the present invention is also of publicly known layout except a rotation restricting means L of a lift member, however, reference is made to the hinge means F, since the operation thereof cooperates with a drive means G. The hinge means F comprises, in particular as shown in FIGS. 1 to 15, a mounting member 1 detachably mounted via a mounting button a on an upper end of a rear portion of a main body B, a supporting member 3 rotatably mounted via a main shaft 2 also serving as hinge pin on the mounting member 1, a lift member 5 mounted via a drive shaft 4 also serving as hinge pin on a free end side of the supporting member 3 so as to rotate in a direction contrary to the supporting member 3, a second rotation control means K also serving as first rotation control means J provided between a side of the mounting member 1 and an actuating member 13 mounted on the lift member 5, a rotation restricting means L of the lift member 5 provided between a free end side of the lift member 5 and the supporting member 3.

Described further in detail, a mounting member 1 comprises a bottom plate 1a, both side plates 1b, 1b extending upward perpendicular to both sides of the bottom plate 1a and a rear plate 1c extending upward perpendicular to a rear portion of the bottom plate 1a and locked between the both side plates 1b, 1b. The bottom plate 1a is provided with a mounting hole 1d on a substantially central portion of a rear end portion and with mounting long holes 1e, 1e elongated in a longitudinal direction on a fore end portion side. The both side plates 1b, 1b are provided with coupling holes 1f, 1f of the main shaft 2 and with locking holes 1g, 1g which locks locking pins 11 of a first spring receiving member 12 described below.

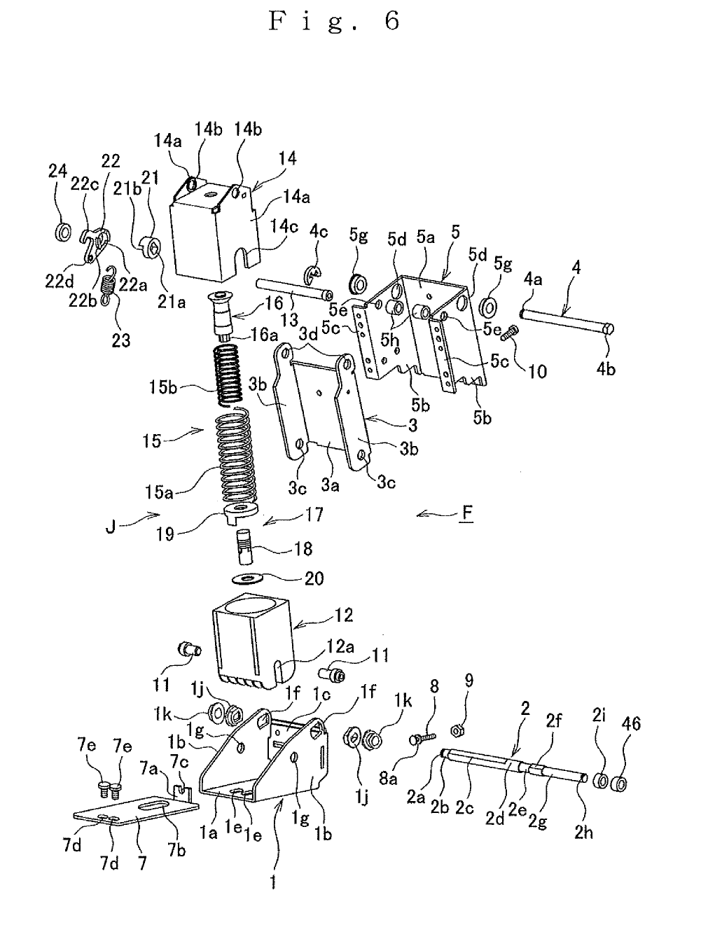

A mounting member 1 as above described is provided with a mounting position adjusting means H for adjusting a mounting position of the mounting member 1 with regard to a main body B. The mounting position adjusting means H comprises an adjusting plate 7 overlapping a bottom plate 1a of a mounting member 1 and an adjusting screw 8 screwed into a rear plate 1c of the mounting member 1, and the adjusting plate 7 has a locking piece 7a, a first adjusting long hole 7b which is so located on the side of the locking piece 7a that the axial center thereof overlaps that of a mounting hole 1d, and second adjusting long holes 7d, 7d elongated in a horizontal direction and overlapping mounting long holes 1e, 1e on the fore end side, wherein a circumferential groove 8a provided on the adjusting screw 8 is engaged with a recess portion 7c provided on the locking piece 7a of the adjusting plate 7. Reference numerals 7e, 7e denote mounting screws. A nut 9 for clamping is also mounted on the adjusting screw 8. Moreover, the rear plate 1c of the mounting member 1 is provided with a through hole 1h used in screwing an adjusting screw 18 as described below with driver, hex wrench or other tool, and an opening angle adjusting plate 1i is mounted on it. Reference numerals 1j, 1j as shown in particular in FIG. 6 denote fixing members inserted and fixed into coupling holes 1f, if provided on both side plates 1b, 1b of the mounting member 1, while reference numerals 1k, 1k denote bearing members mounted in first coupling holes 3c, 3c provided on the both side plates 3b, 3b of the supporting member 3.

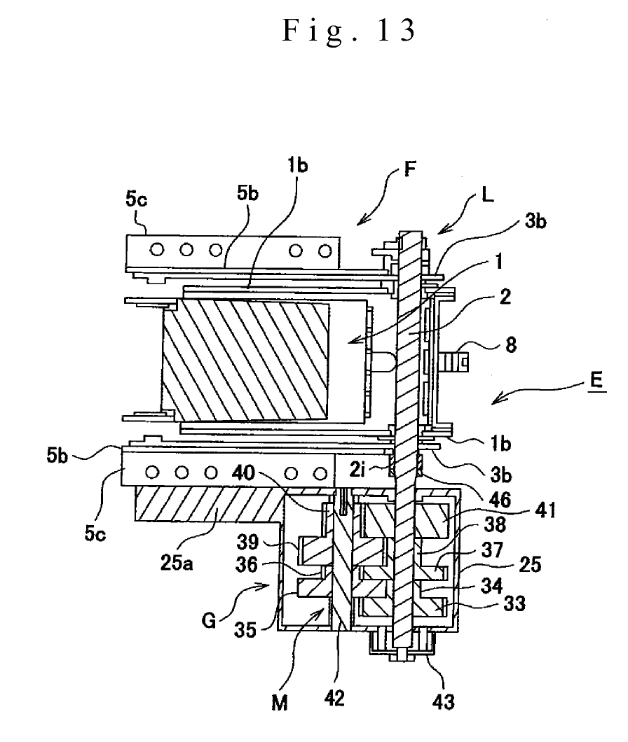

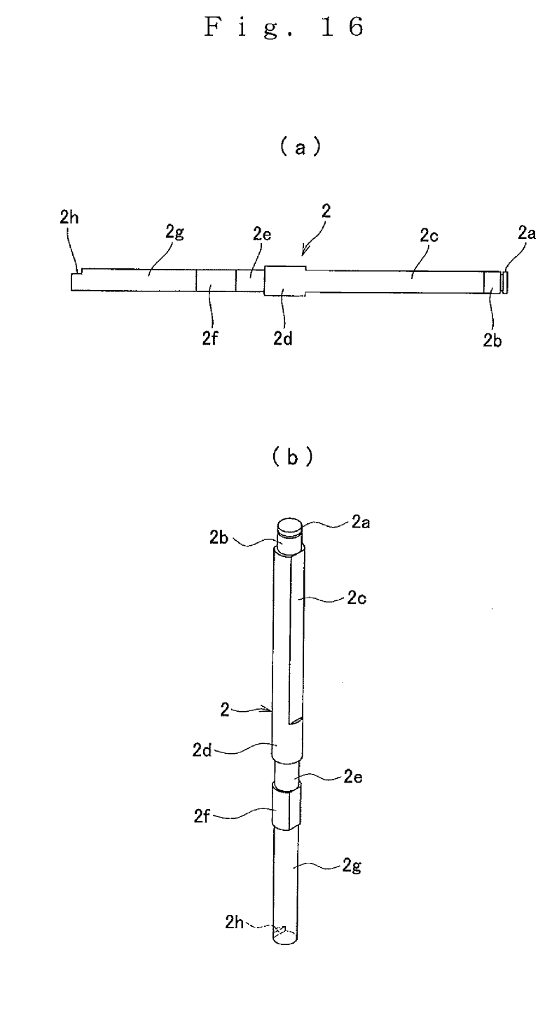

Next, a main shaft 2 comprises, as shown in particular in FIGS. 16A and 16B, a first circular shaft portion 2b provided with a circumferential groove 2a on one end side, a first deformed shaft portion 2c provided in a continuous manner from the first circular shaft portion 2b, a second circular shaft portion 2d provided in a continuous manner from the first deformed shaft portion 2c, a third circular shaft portion 2e provided in a continuous manner from the second circular shaft portion 2d, a second deformed shaft portion 2f provided in a continuous manner from the third circular shaft portion 2e, a fourth circular shaft portion 2g provided in a continuous manner from the second deformed shaft portion 2f, a third deformed shaft portion 2h provided in a continuous manner from the fourth circular shaft portion 2g. The first circular shaft portion 2b as well as the third circular shaft portion 2e and the portions closer to a tip protrude outward from respective both side plates 1b, 1b of a mounting member 1, and part of the first circular shaft portion 2b and the second deformed shaft portion 2f is provided with a rotation restricting means L as described below. Further, the second deformed shaft portion 2f and the portions closer to a tip reach to the inside of a drive case 25 of a drive means G. In the meantime, reference numeral 2i denotes a fixing ring. The main shaft 2 is, in particular as shown in FIGS. 6 and 13 and others, provided with a distortion detecting means 46 such as distortion gauge. The embodiment, assembled as above described, enables to detect a distortion accompanied by rotation of the main shaft 2, and to actuate a drive motor 26 in order to assist in opening and closing operation, in case that an original cover is manually opened and closed when the drive motor 26 stops.

Next, a supporting member 3 has a top plate 3a and both side plates 3b, 3b extending downward perpendicular to both sides of the top plate 3, and the both side plates 3b, 3b are provided on a rear side thereof with first coupling holes 3c, 3c, to which the main shaft 2 fixed into coupling holes 1f, 1f of a mounting member 1 is coupled. Further, the both side plates 3b, 3b are provided with second coupling holes 3d, 3d on their respective tip sides for rotatably mounting a lift member 5 via a drive shaft 4 on a supporting member 3.

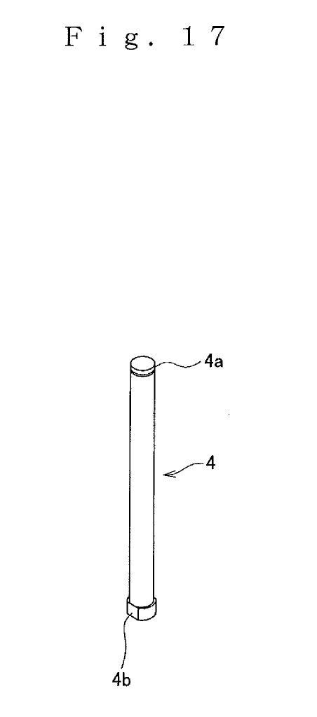

Next, a drive shaft 4 is, as shown in particular in FIG. 17, shaped in round bar and has a circumferential groove 4a provided on one end portion and a deformed portion 4b provided on other end portion. Further, an E ring 4c is mounted on the circumferential groove 4a protruding from one of the both side plates 5b, 5b of the lift member 5, and a case plate 25a is fixed to a portion protruding from other.

A lift member 5 has a top plate 5a, both side plates 5b, 5b extending downward perpendicular to both sides of the top plate 5, and mounting plates 5c, 5c formed by folding outward at the bottom end portions of the both side plates 5b, 5b. The both side plates 5b, 5b are pivotally supported via a drive shaft 4 on both side plates 3b, 3b of a supporting member 3, so as to be rotatable. The lift member 5 is additionally provided with first coupling holes 5d, 5d for mounting the drive shaft 4 at a vertical position toward the tip side and second coupling holes 5e, 5e for coupling to an actuating member 13 as described below. In the meantime, reference numerals 5h, 5h denote collars, while numerals 5g, 5g bearing members.

A height adjusting means I for adjusting height for mounting of an original cover C is further provided between a top plate 5a of a lift member 5 and a top plate 3a of a supporting member 3. The height adjusting means I is an adjusting screw 10 mounted by screwing through on the top plate 5a of the lift member 5. A tip of the adjusting screw 10 abuts against the top plate 3a of the supporting member 3 and rotation of the adjusting screw 10 causes a slight rotation of the lift member 5 in a vertical direction with a supporting point at a drive shaft 4, which then enables to adjust the height of the original cover C mounted on mounting plates 5c, 5c of the lift member 5. A clamping nut may be additionally coupled to the adjusting screw 10.

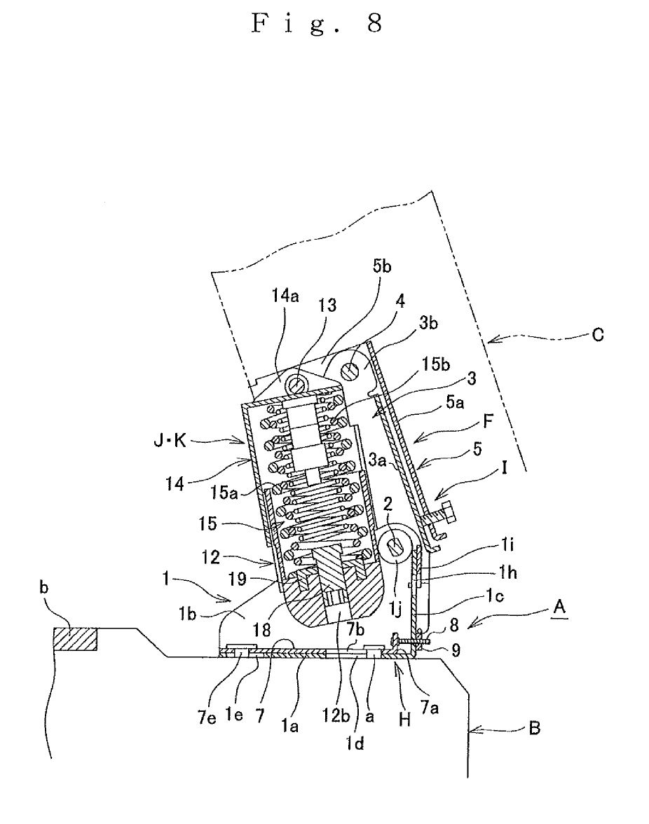

A first rotation control means J provided by rotatably urging a lift member 5 toward a supporting member 3 for controlling an inverse rotation of the lift member 5 comprises, as shown in particular in FIGS. 6 and 8, a first spring receiving member 12 in a hollow-case shape made e.g. of synthetic resin and formed by swingably engaging engagement grooves 12a, 12a (of which only one is shown) provided on lower end portions thereof with locking pins 11, 11 coupled to locking holes 1g, 1g provided on both side plates 1b, 1b of a mounting member 1, a second spring receiving member 14 in a case-like shape coupled to second coupling holes 5e, 5e of the lift member 5 and formed by slidably accommodating the first spring receiving member 12 into the interior thereof, in which an actuating member 13 e.g. in a pin-like shape is swingably coupled to coupling holes 14b, 14b provided on a top of both side plates 14a, 14a thereof, and a resilient means 15 consisting of large and small compression springs, e.g. a first compression spring 15a and a second compression spring 15b which are accommodated and resiliently provided in the first spring receiving member 12 and the second spring receiving member 14, respectively. In the meantime, long grooves 14c, 14c (of which only one is shown) provided on the lower end portions of the both side plates 14a, 14a of the second spring receiving member 14 are escape grooves of locking pins 11, 11.

In the meantime, a layout of a first rotation control means J as above described is not limited to the one described in embodiment 1. For example, a layout is also possible wherein a torsion coil spring is wound round a drive shaft 4 assembled with the first rotation control means J as above described or being an independent assembly without it, and one end portion of the drive shaft 4 is locked on a side of a supporting member 3 while the other end portion on the side of a lift member 5, so that the lift member 5 is rotatably urged toward a direction in which it overlaps the supporting member 3. In this case, a resilient means 15 can be designed as above described, but also resiliently provided toward a top plate provided on a free end side of the supporting member 3. Moreover, the first rotation control means J can be omitted in a layout of a mounting member 1 in a one-leg shape into a mounting hole (not shown) provided on the main body B so as to be vertically movable with regard to it, since in this case the lift member 5 itself is not necessary. Additionally, an actuating member 13 is not necessarily formed in a pin-like shape, but can be an element not in a pin-like shape mounted on the side of the lift member 5.

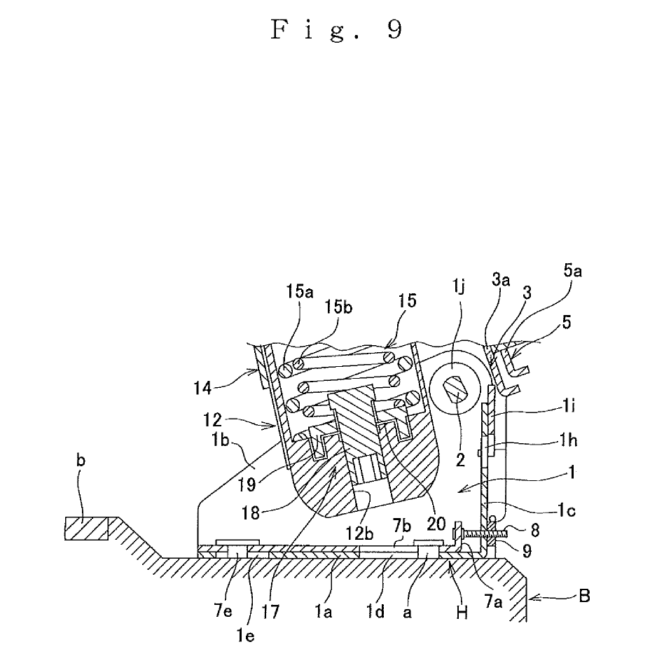

Next, a second rotation control means K has a common layout with a first rotation control means J, and it suffices, as shown in particular in FIGS. 6 and 9, to comprise a first spring receiving member 12 in a hollow-case shape made e.g. of synthetic resin and formed by swingably engaging engagement grooves 12a, 12a (of which only one is shown) provided on lower end portions thereof with locking pins 11, 11 coupled to locking holes 1g, 1g provided on both side plates 1b, 1b of a mounting member 1, a second spring receiving member 14 mounted on second coupling holes 5e, 5e of a lift member 5, in which an actuating member 13 e.g. in a pin-like shape is swingably coupled to coupling holes 14b, 14b provided on a top of both side plates 14a, 14a thereof, and a resilient means 15 consisting of large and small compression springs, e.g. a first compression spring 15a and a second compression spring 15b which are accommodated and resiliently provided in the first spring receiving member 12 and a second spring receiving member 14, respectively.

However, embodiment 1 is so designed, in particular consideration of a heavy weight of an original cover C, that a second rotation control means K as above described is further equipped with a fluid damper means 16 and a resilient force adjusting means 17 of a resilient means 15. Further, a second spring receiving member 14 can also be designed in a rectangular tube shape so that it accommodates a first spring receiving member 12 in the interior thereof, in order to achieve a damper action using mutual fitting state.

A fluid damper means 16 has a piston rod 16a and is therefore of publicly known layout. A resilient force adjusting means 17 comprises an adjusting screw 18 rotatably coupled to an adjusting hole 12b provided on an inner bottom portion of a first spring receiving member 12, an adjusting plate 19 fixed by screwing to the adjusting screw 18 and a positioning plate 20 for positioning the adjusting screw 18.

In the meantime, a fluid damper means 16 and a resilient force adjusting means 17 are, although the object of the present invention can be achieved even without them as above stated, desirable components in a heavy original cover weighing some 20-30 kg. Further, a layout of a second rotation control means K is not limited to that in an embodiment as above described, but may be substituted e.g. with a publicly known layout, wherein a cam member is provided on the side of a mounting member, a slider is provided on the side of a supporting member with the tip thereof abutting against the cam member, and a resilient means is so provided that the slider can be contacted under pressure toward the supporting member.

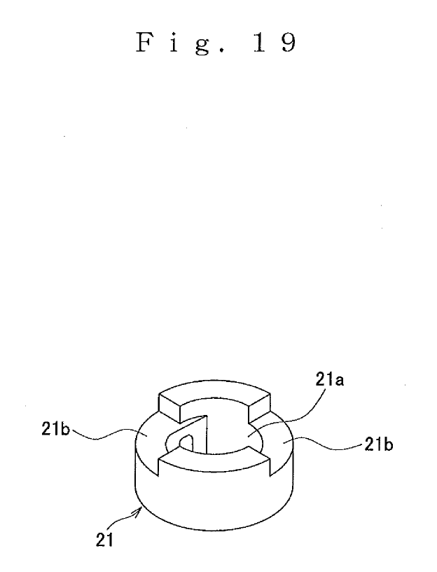

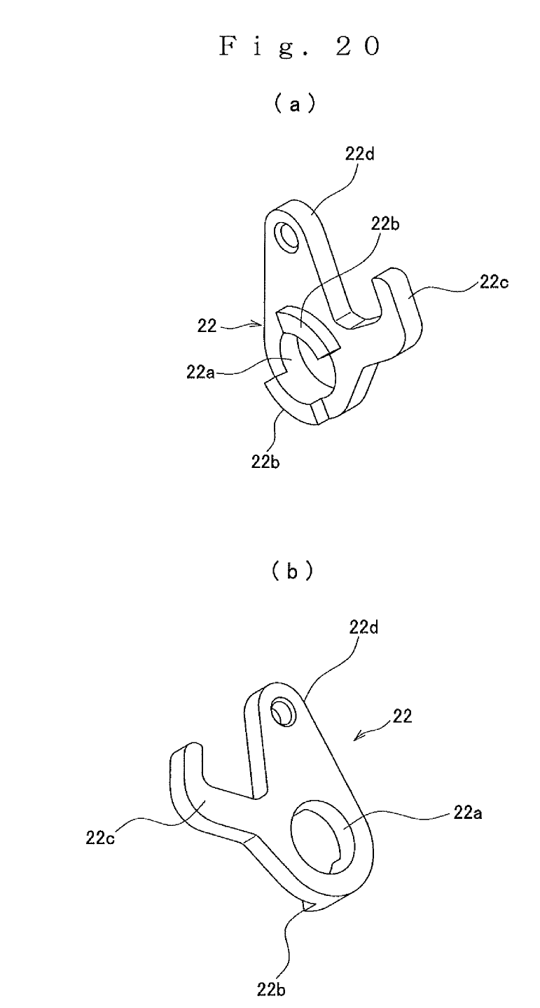

Next, a rotation restricting means L comprises, as shown in particular in FIGS. 19 and 20, a first locking member 21 in a cylindrical shape having a pair of engagement recess portions 21b, 21b on one side portion and restricted in rotation by attaching and fixing a first deformed shaft portion 2c of a main shaft 2 to a deformed mounting hole 21a, a second locking member 22 having an insertion hole 22a, a pair of engagement convex portions 22b, 22b provided around the insertion hole 22a and an engagement portion 22c and a locking portion 22d, both provided respectively in a vertical direction, and formed by rotatably inserting a first circular shaft portion 2b of a main shaft 2 into the insertion hole 22a, a locking pin 5f engaged with the engagement portion 22c of the second locking member 22 and mounted on a side plate 5b of a lift member 5 and e.g. a tension coil spring 23 stretchingly provided by locking one end portion at the locking portion 22d of the second locking member 22 and other end portion at a locking pin 3e mounted on a side plate 3b of a supporting member 3. In the meantime, reference numeral 24 denotes a fixing ring for preventing escape. Then, the engagement recess portions 21b, 21b of the first locking member 21 and the engagement convex portions 22b, 22b of the second locking member 22 engage each other, and a small gap g is provided between the engagement recess portions 21b, 21b and the engagement convex portions 22b, 22b.

Next, a layout of a drive means G is described. The drive means G comprises a drive case 25 mounted on a main shaft 2 and a drive shaft 4, a drive motor 26 as a power source such as a stepping motor mounted in the inside of the drive case 25, a first endless belt 27a such as a timing belt for transmitting rotation drive force of a rotation pulley 27 mounted on a rotation axis 26a of the drive motor 26 to e.g. a clutch pulley 29 of an electromagnetic clutch means 28, a reduction mechanism M for transmitting rotation drive force from a rotation axis 30 of an electromagnetic clutch means 28 to the main shaft 2.

A reduction mechanism M as above described comprises a first reduction pulley 31 mounted on a rotation axis 30 of a clutch pulley 29 of an electromagnetic clutch means 28, a second reduction pulley 33 for transmitting rotation drive force of the first reduction pulley 31 via a second endless belt 32 such as timing belt, a first gear 34, a second gear 35, a third gear 36, a fourth gear 37, a fifth gear 38, a sixth gear 39 and a seventh gear 40, these gears transmitting rotation drive force of the second reduction pulley 33 to a main shaft 2, and a drive gear 41; the drive gear 41 is fixed on the main shaft 2. Then, a tip of a case plate 25a of a drive case 25 on the side of a hinge means F is coupled and fixed to a drive shaft 4.

Namely, a second reduction pulley 33, a first gear 34, a fourth gear 37 and a fifth gear 38 are pivotally supported on a main shaft 2 so as to rotate with regard to it. A second gear 35, a third gear 36, a sixth gear 39 and a seventh gear 40 are pivotally supported on a gear support shaft 42 so as to rotate with regard to it. A rotation angle sensor 43 of the main shaft 2 and a supporting member 3 is mounted on a tip of the main shaft 2.

An original cover C is mounted via mounting pieces c, c on mounting plates 5c, 5c of a lift member 5. A drive case 25 is mounted on a main shaft 2 and a drive shaft 4, and not mounted as such on the original cover C. In the meantime, other embodiment can be also conceived in this regard, in layouts without a supporting member 3 of a hinge means F or without a lift member 5, wherein a drive case 25 is directly mounted on the original cover C.

Moreover, a layout of a drive means G is not limited to an embodiment as above described. The drive means G suffices to comprise at least a drive motor 26 and a reduction mechanism M, but is advantageous in that operability and function are improved, if it is equipped at least with an electromagnetic clutch means 28 or other clutch means and a rotation angle sensor 43. Further, a layout using two or more endless belts will be advantageous in that it can effectively prevent backlash from occurring.

In the following, an operation of the automatic opening/closing device E according to embodiment 1 is described.

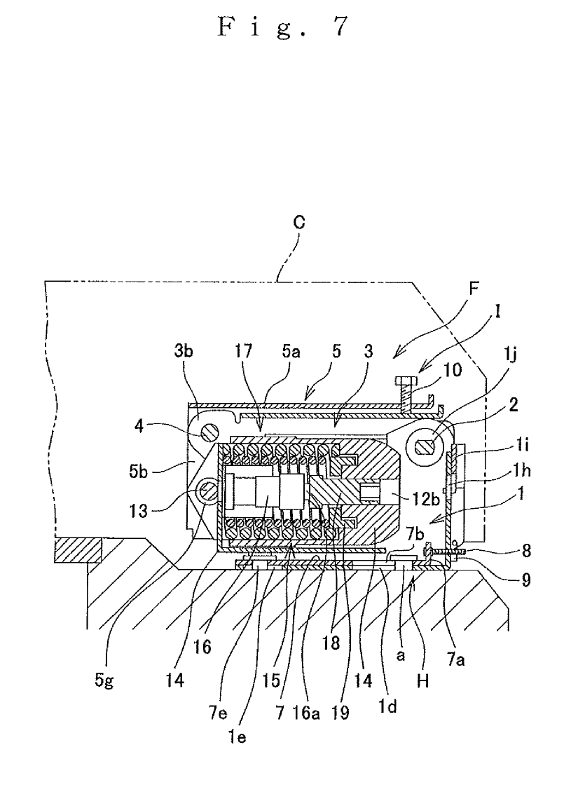

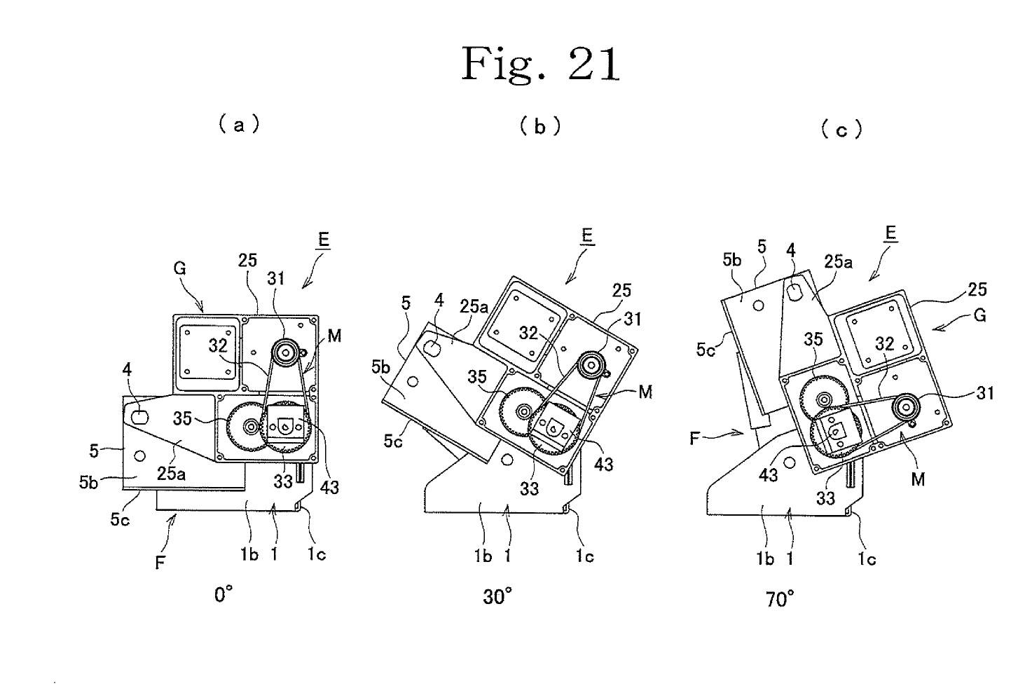

First, as shown in FIG. 21A, the drive motor 26 of the drive means G stops, when the original cover C is closed. As shown in particular in FIG. 7, the tip of the piston rod 16a of the fluid damper means 16 of a hinge means F abuts against the head portion of the adjusting screw 18. Then, in the closed state of the original cover C, the resilient force of the resilient means 15 is weaker than the weight of the original cover C, thus the original cover C stably keeps the position thereof in the closed state. In the meantime, it is also possible in this regard that the closed state is stably kept by setting the operation direction of the resilient means 15 downward.

When the opening/closing switch 44 for opening provided on the side of the main body B so as to open the original cover C is pressed in the closed state, the drive motor 26 is turned on and the rotation drive force thereof is transmitted via the reduction mechanism M to the drive gear 41.

Since the drive gear 41 is fixed on the main shaft 2, the drive case 25 is rotated to the opening direction of the original cover C. At this point, the supporting member 3 is rotated together with the drive case 25 with a supporting point at the main shaft 2 to open the original cover C, since the drive case 25 is coupled via the drive shaft 4 to the supporting member 3.

When the original cover C is opened at the predetermined opening angle (about 70° in the embodiment), the rotation angle sensor 43 detects the opening angle to turn off the drive motor 26, so that the original cover C stops at the angle. When the original to be copied is set on the platen glass b on the side of the main body B and the switch 45 for closing is pressed, the drive motor 26 is rotated in a direction contrary to the above mentioned, so that the original cover C is closed. At this point, the closing angle of the original cover C is detected by the rotation angle sensor 43, and when the drive motor 26 stops at a closing angle of 15°, the original cover C is closed by the own weight thereof even with the drive motor 26 stopping, since the weight of the original cover C exceeds the resilient force of the resilient means 15. Then, the embodiment prevents the main body B from receiving impact or pinching the hand, by allowing the tip of the piston rod 16a of the fluid damper means 16 to abut against the head portion of the adjusting screw 18 at a closing angle about 5° and then to assume a damper action, so as to avoid a sudden drop of the original cover C. In the meantime, the maximum opening angle of the original cover C is about 90°±5°, while an angle at which the original cover C start closing by the own weight thereof is about 15°±5° in practice. Since the hinge means F is provided with the second rotation control means K, an angle at which the original cover C assumes the free stop state is about 60°±5° from the angle at which the original cover C falls by the own weight thereof. In the meantime, a friction mechanism using friction washers for which illustration and description are omitted can be additionally provided, in order to achieve free stop function of the original cover C.

In the meantime, the opening operation of the original cover C from the closed state can be also manually conducted without using the drive motor 26. In this case, when the fore side of the original cover C is lifted upwards by hands, the original cover C is rotated together with the supporting member 3 with a supporting point at the main shaft 2 to allow for opening. In this case, the rotation drive force of the main shaft 2 is not transmitted by the electromagnetic clutch means 28 to the drive motor 26. However, a layout is practicable, wherein a rotation of the original cover C during a manual opening/closing operation is detected by the rotation angle sensor 43 to turn on the drive motor 26.

Moreover, a layout is also possible in this regard, wherein distortion of the main shaft 2 accompanied by a manual opening operation of the original cover C is detected by the distortion detecting means 46 to turn on the drive motor 26 and to assist in the manual opening operation. Further, the distortion detecting means 46 can be also mounted on the side of the drive shaft 4.

Still further, the original cover C in the opened state can be also manually closed. In this case, when hands are placed on the original cover C on the side thereof close to the operator, the original cover C is closed via the supporting member 3 with a supporting point at the main shaft 2. At this point, the rotation drive force to be transmitted via the main shaft 2 and the reduction mechanism M to the drive motor 26 is cancelled by the electromagnetic clutch means 28 and not transmitted to the drive motor 26.

However, an arrangement is also possible, wherein rotation of the main shaft 2 accompanied by a manual opening operation of the original cover C is detected by the rotation angle sensor 43 and the distortion detecting means 46 to rotate the drive motor 26 in an inverse direction, so that the original cover C is automatically closed. In this case also, the drive motor 26 is turned off at the predetermined opening angle, the original cover C is closed by the own weight and the fluid damper means 16 and other damper means not shown operate at the predetermined opening angle.

The hinge means F according to the present embodiment 1 comprises the second rotation control means K, so that the original cover C can be opened in opening the original cover C, with the original weight of the original cover C being reduced, while it can be closed without suddenly dropping by the weight thereof in closing it.

The first rotation control means J rotatably urges the lift member 5 to a direction in which it overlaps the supporting member 3, and when the voluminous original such as book is set on the platen glass b of the original cover C once manually or automatically opened and the original cover C is closed, for the first rotation control means J according to the present embodiment 1, the original cover C abuts against the end portion of the voluminous original, so that the lift member 5 is inversely rotated with a supporting point at the drive shaft 4. In this manner, the original cover C flatly covers the top surface of the voluminous original, and the first rotation control means J can prevent outside light from reaching to the interior of the main body B as much as possible.

The rotation restricting means L of the lift member 5 prevents a so-called “center crease” phenomenon, wherein the lift member 5 is rotated with a supporting point at the drive shaft 4 even with the first rotation control means J which cannot by itself bear the rotation torque then generated due to a large opening/closing device D mounted on the right of the main body B, when the opened original cover C is closed together with the supporting member 3, in particular for the heavy original cover C. Then, in the present invention, the locking pin 5f mounted on one of the both side plates 5b, 5b of the lift member 5 is locked by the second locking member 22 of the rotation restricting means L via the engagement portion 22c thereof, and even the heavy original cover C is inversely rotated at a normal closing operation so that a so-called “center crease” phenomenon is eliminated.

In the meantime, the gap g is provided since a “center crease” phenomenon of the lift member 5 as above described frequently occurs when the original cover C once opened is closed using the drive means G. The gap g prevents the engagement recess portions 21b, 21b of the first locking member 21 and the engagement convex portions 22b, 22b of the second locking member 22 from engaging although the first locking member 21 is rotated via the main shaft 2 rotated together with the original cover C in opening, so that the second locking member 22 still locks the locking pin 5f. When the original cover C is opened at the predetermined opening angle, i.e. at the angle at which the voluminous original is accepted, the second locking member 22 is rotated so as to release the locking pin 5f from an engagement by the engagement portion 22c. In short, the rotation restricting means L restricts the inverse rotation within the predetermined range of opening/closing angle.

In the meantime, the embodiment can be so designed that locking of the second locking member 22 and the locking pin 5f is released by the rotation torque then generated, when the voluminous original is set on the platen glass b and the original cover is pressed hard on the side close to the operator toward the closing direction, so that the inverse rotation of the original cover C is allowed.

At this point, the original cover C according to the present invention is inversely rotated against the rotation restriction force of both the first rotation control means J and rotation restricting means L.

In the meantime, either one of the first rotation control means J and rotation restricting means L may suffice as in the conventional devices, depending on the layout of the hinge means F.

### Embodiment 2

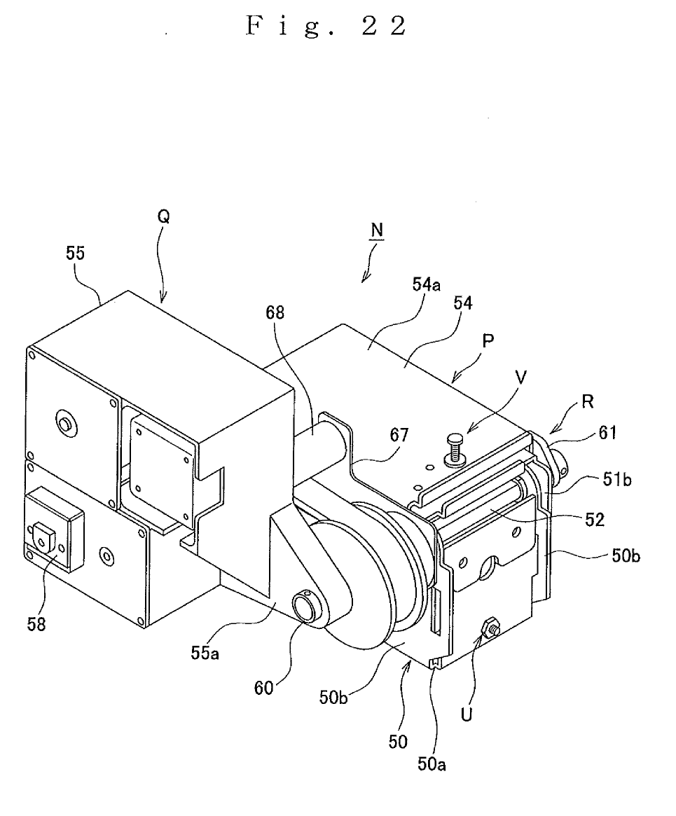

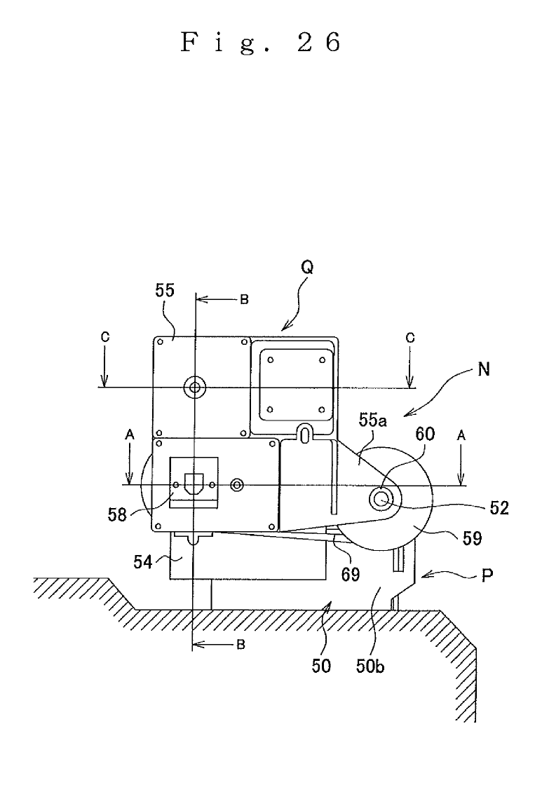

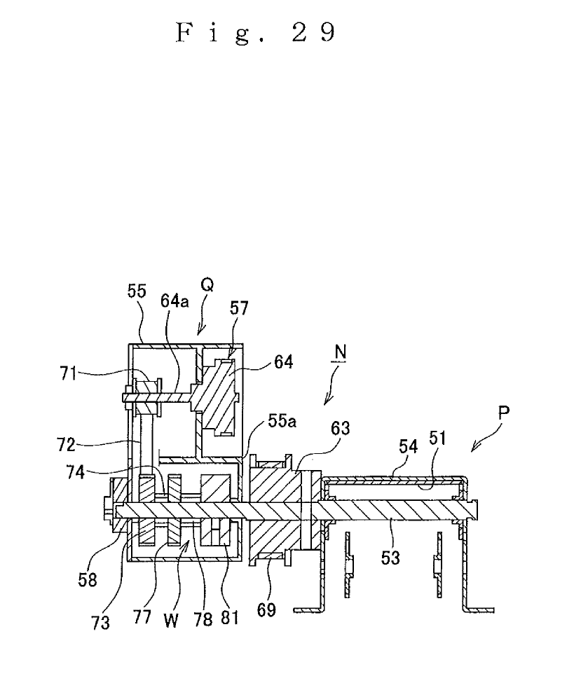

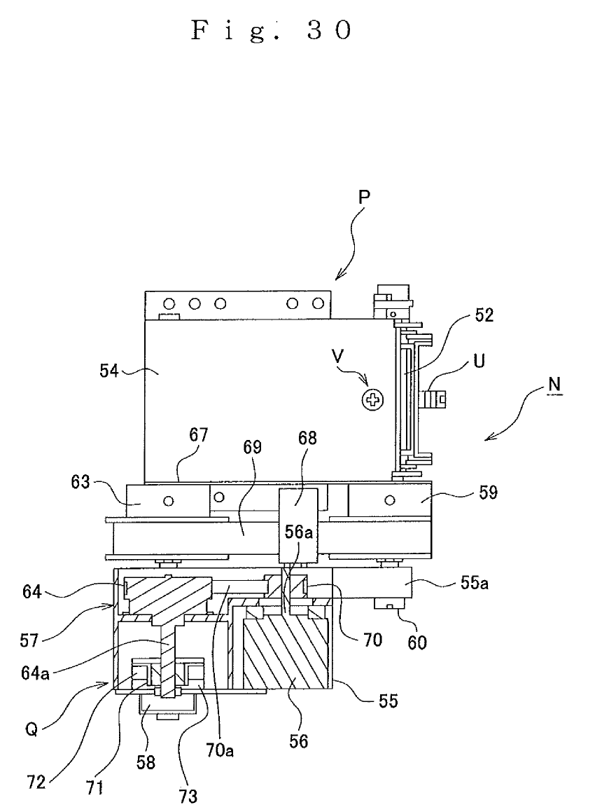

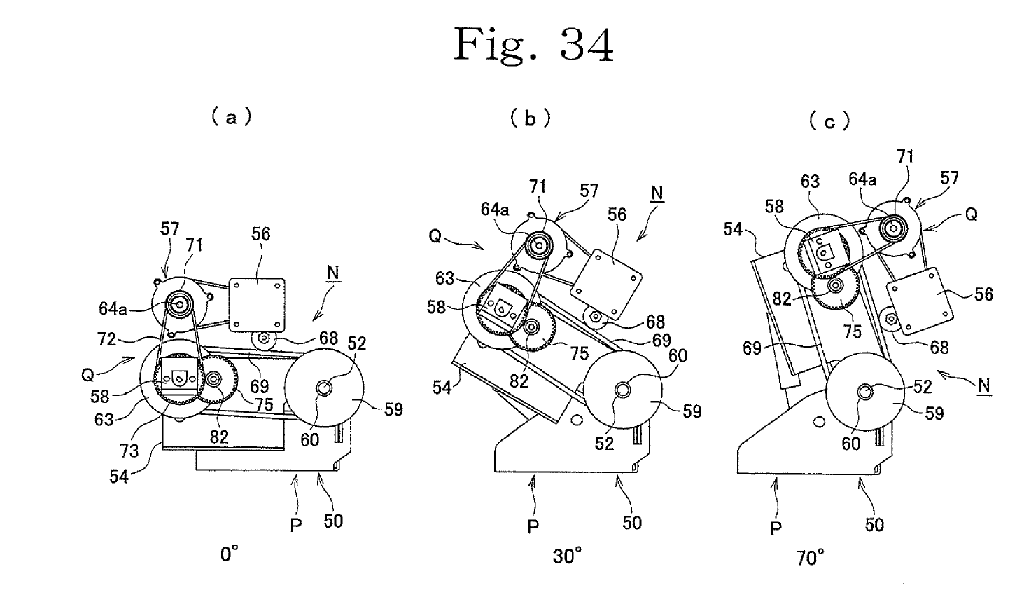

FIGS. 22 to 34 show other embodiment according to the present invention. According to the drawings, an automatic opening/closing device N according to this embodiment 2 is remarkably distinct from an automatic opening/closing device E according to embodiment 1 in that an operating point of a drive means lies on a drive shaft 4 on a free end side of a supporting member 3 on which a drive case 25 is mounted in embodiment 1, while it lies on a side of a drive shaft 52 rotatably mounted on a mounting member 50 on a base end side of a supporting member 51 in this embodiment 2.

A layout of a hinge means P is substantially the same as that of a hinge means F in embodiment 1, but differs from the latter in that a main shaft 2 in embodiment 1 is a drive shaft 52 and a drive shaft 4 in embodiment 1 is a main shaft 53.

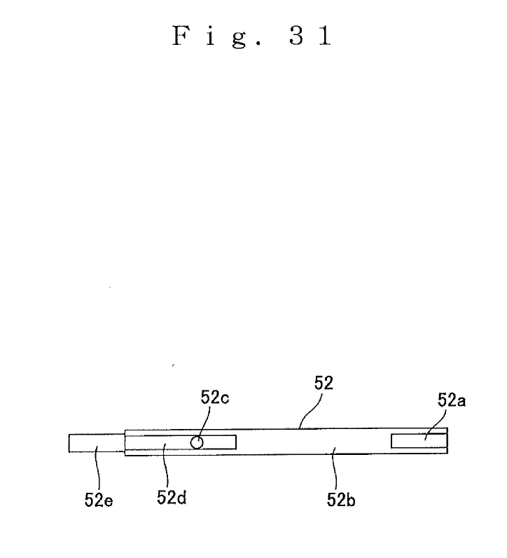

Namely, a drive shaft 52 in this embodiment 2 comprises, as shown in particular in FIG. 31, a first deformed shaft portion 52a, a large diameter shaft portion 52b, a second deformed shaft portion 52d having a mounting hole 52c and a small diameter shaft portion 52e, as seen in sequence from one end portion.

A drive shaft 52 as above described couples at the same time both side plates 51b, 51b formed by folding a top plate 51a of a supporting member 51 to both side plates 50b, 50b formed by folding a bottom plate 50a of a mounting member 50, and is so designed that it rotates, accompanied by the own rotation, the supporting member 51 by engaging a first deformed shaft portion 52a and a second deformed shaft portion 52d thereof with deformed mounting holes (not shown) of the both side plates 51b, 51b of the supporting member 51.

In a drive shaft 52 as above described, an area of a large diameter shaft portion 52b is rotatably coupled to circular coupling holes (not shown) of both side plates 50b, 50b of a mounting member 50, one end portion protrudes outward from one side plate 51b of a supporting member 51 and a first deformed shaft portion 52a is equipped with a rotation restricting means R of a lift member 54. A second deformed shaft portion 52d and a portion closer to a tip of the drive shaft 52 protrude outward from other side plate 51b of the supporting member 51, and a drive pulley 59 of a drive means Q as described below is fixed on the second deformed shaft portion 52d via a mounting screw 59a passing through a mounting hole 52c, so as to rotate together with the drive shaft 52. Moreover, a small diameter shaft portion 52e of a drive shaft 52 is pivotally supported on a pivotally supporting hole (not shown) of a case cover 55a of a drive case 55, and a fixing ring 60 for preventing escape is mounted on the tip thereof.

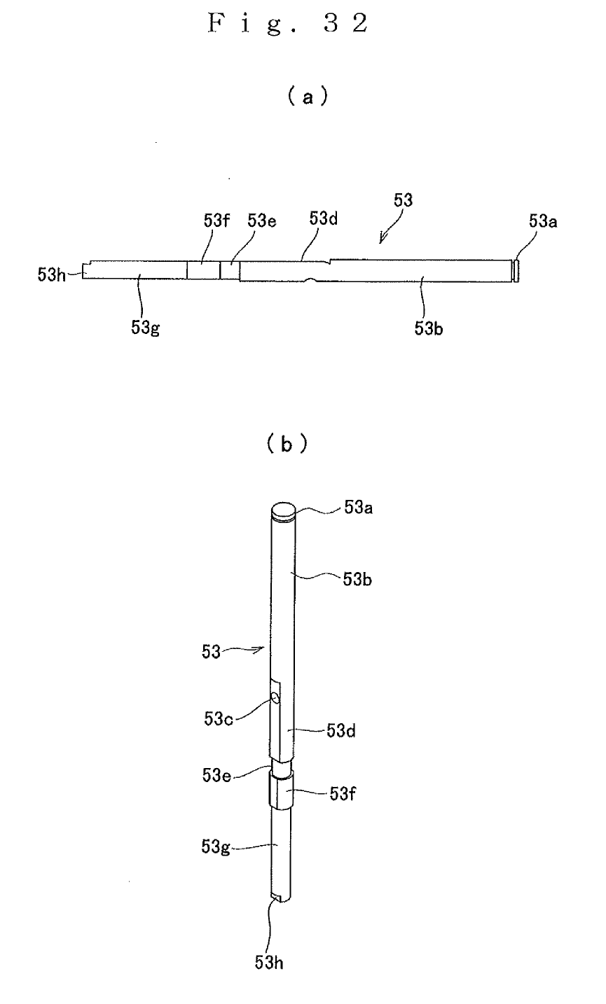

A main shaft 53 comprises, as shown in particular in FIGS. 32A and 32B, a circumferential groove 53a provided on one end portion thereof, a first circular shaft portion 53b provided in a continuous manner from the circumferential groove 53a, a first deformed shaft portion 53d having a mounting hole 53c provided in a continuous manner from the first circular shaft portion 53b, a second circular shaft portion 53e provided in a continuous manner from the first deformed shaft portion 53d, a second deformed shaft portion 53f provided in a continuous manner from the second circular shaft portion 53e, a third circular shaft portion 53g provided in a continuous manner from the second deformed shaft portion 53f and a third deformed shaft portion 53h provided in a continuous manner from the third circular shaft portion 53g.

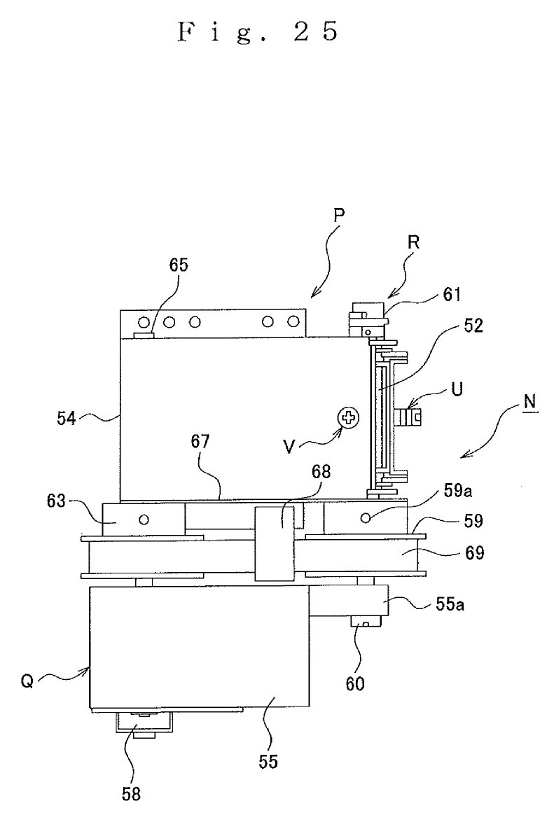

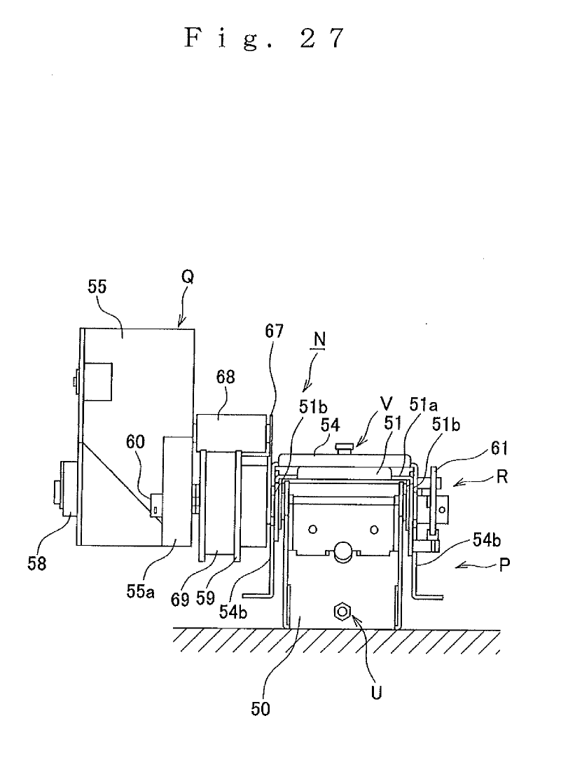

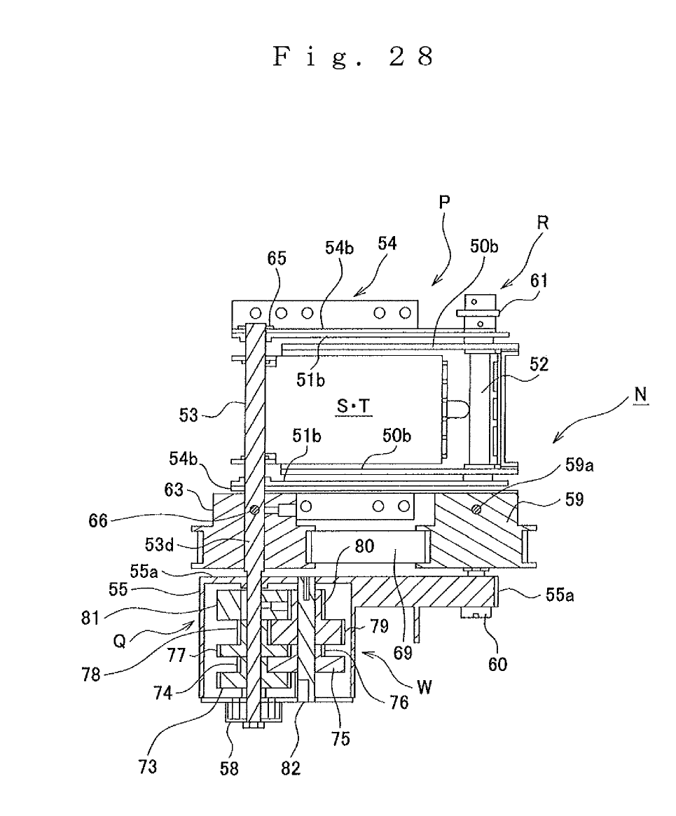

An area of a first circular shaft portion 53b of a main shaft 53 is, as shown in particular in FIGS. 27 and 28, coupled to second coupling holes and first coupling holes (not shown) provided respectively on both side plates 51b, 51b of a supporting member 51 and both side plates 54b, 54b extending downward perpendicular to a top plate 54a of a lift member 54. Then, an E ring 65 for preventing escape is fitted on an area of a circumferential groove 53a of the main shaft 53 protruding from one side plate 54b of the lift member 54, as shown in particular in FIG. 25. A main pulley 63 of a drive means Q is, as shown in particular in FIG. 28, fixed via a mounting screw 66 passing through a mounting hole 53c on a first deformed shaft portion 53d being a protrusion of the main shaft 53 from other side plate 54b of the lift member 54. Further, a second deformed shaft portion 53f and portions closer to a tip are inserted in the inside of the drive case 55.

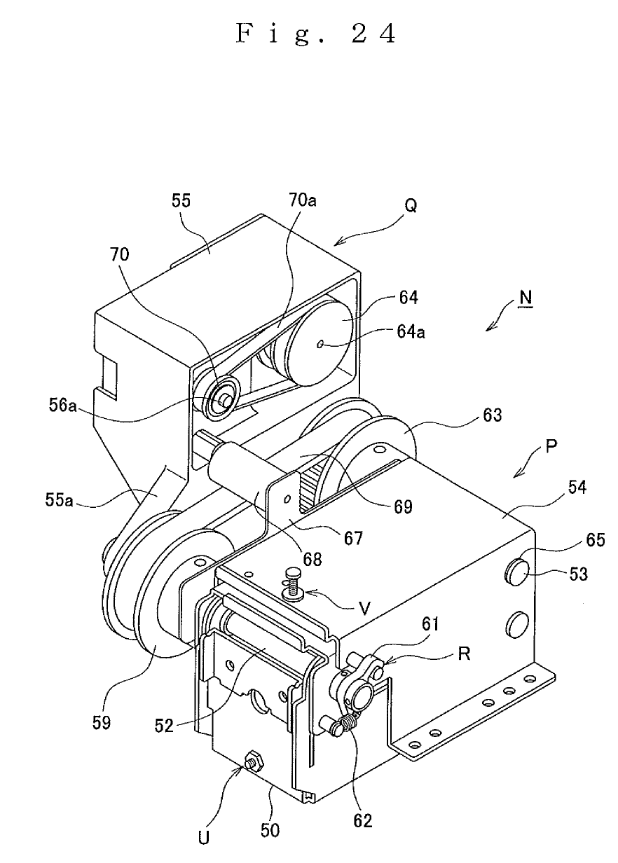

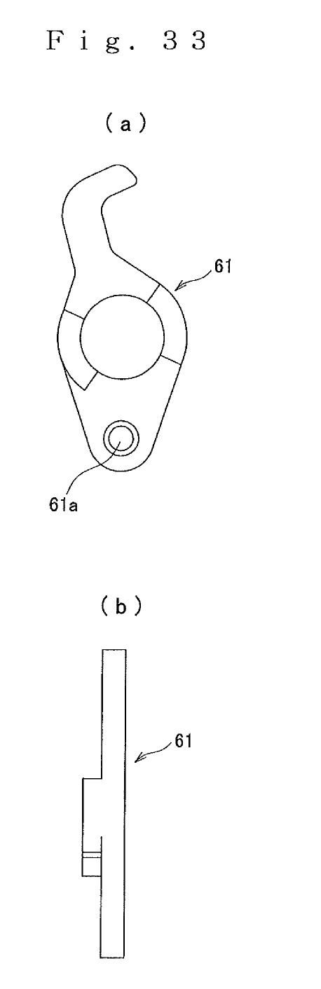

In a rotation restricting means R, a shape of a second locking means 61 is merely distinct from that of a second locking member 22 in embodiment 1, and the remaining layout is not subject to substantial changes. Namely, the second locking means 61 according to embodiment 2 uses, as shown in particular in FIGS. 24 and 33, a locking hole 61a for locking one end portion of a tension coil spring 62, instead of a locking portion 22d of the second locking member 22 in embodiment 1. The operation and effect thereof is not different from those of embodiment 1, thus the description is omitted.

The remaining components of a hinge means P are the same as those in embodiment 1, therefore the description is omitted in this regard. Further, layouts of a mounting position adjusting means U, a height adjusting means V, a first rotation control means S and a second rotation control means T provided on the hinge means P are the same as those in embodiment 1, therefore sufficient illustration and description are omitted in this regard.

Moreover, layout of a hinge means P is not limited to that in this embodiment 2 as described above and shown in this regard, in the same manner as described above with regard to embodiment 1. In this regard, other hinge means of publicly known layout or not described hinge means can be used, unless there are obstacles for cooperation with drive means.

A drive means Q according to this embodiment 2 is the same as that in embodiment 1, in that it comprises a drive case 55, a drive motor 56, an electromagnetic clutch means 57, a reduction mechanism W, a rotation angle sensor 58 and others, but their location and assembly are different in part. Explanation is made hereinafter.

A drive case 55 is mounted on a drive shaft 52 and a main shaft 53 which pass through a case cover 55a of the drive case 55, and thus it is not directly mounted on an original cover C. And it is so designed that, when a drive pulley 59 rotates, the drive case 55 as a whole is rotated together with a supporting member 51 with a supporting point at the drive shaft 52 provided on the side of the mounting member 50.

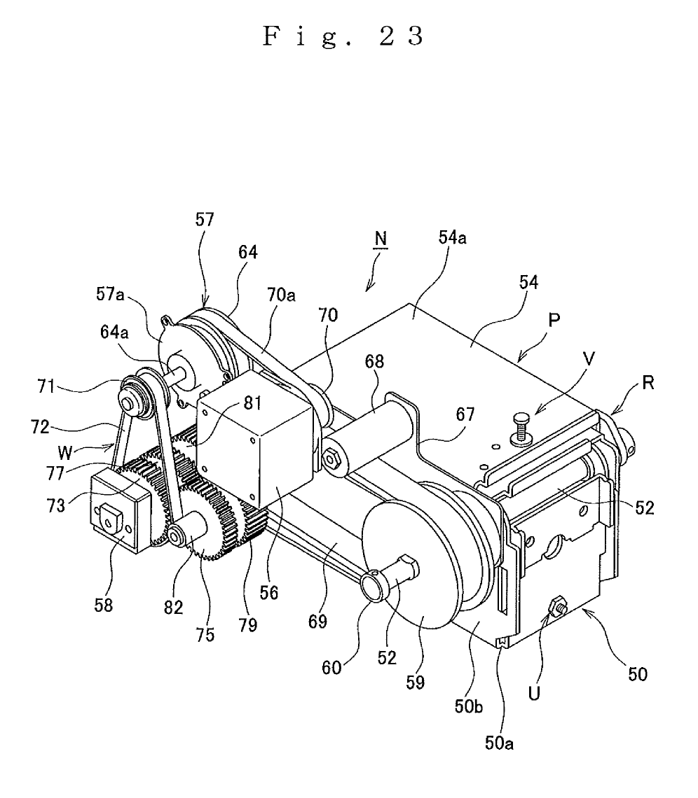

A drive means Q according to this embodiment 2 is, as shown in particular in FIGS. 22 and 23, provided with an electromagnetic clutch means 57 mounted via a mounting plate 57a, a reduction mechanism W, a rotation angle sensor 58 and others, all on the fore portion side of a drive case 55. It is thus different from that in embodiment 1, in that an electromagnetic clutch means 28, a reduction mechanism M, a rotation angle sensor 43 and others are not provided on the rear portion side of a drive case 25, and that a rotation drive force of a main pulley 63 is transmitted by rotation thereof to a drive pulley 59 mounted on a drive shaft 52 via a third endless belt 69 such as a timing belt. Further, the layout is also different in that a mounting plate 67 as mounted on a drive shaft 52 and a main shaft 53 is provided between one side plate 54b of a lift member 54 and a drive case 55, wherein a tension roller 68 for applying a tension to a third endless belt 69 is mounted on a mounting plate 67.

A drive means Q according to this embodiment 2 is, as shown in particular in FIG. 24, so designed that a rotation drive force of a rotation pulley 70 mounted on a rotation axis 56a of a drive motor 56 is transmitted via a first endless belt 70a such as timing belt, as well as via an electromagnetic clutch means 57, a reduction mechanism W, a main pulley 63 and a drive pulley 59 to a drive shaft 52, wherein the reduction mechanism W comprises a first reduction pulley 71 mounted on a rotation axis 64a of a clutch pulley 64 of the electromagnetic clutch means 57, a second reduction pulley 73 for transmitting a rotation drive force of the first reduction pulley 71 via a second endless belt 72 such as timing belt, a first gear 74, a second gear 75, a third gear 76, a fourth gear 77, a fifth gear 78, a sixth gear 79 and a seventh gear 80, these gears transmitting rotation drive force of the second reduction pulley 73 to a main shaft 52, as shown in FIG. 28, and a drive gear 81; the drive gear 81 is fixed on the main shaft 53. Namely, a second reduction pulley 73, a first gear 74, a fourth gear 77 and a fifth gear 78 are pivotally supported on a main shaft 53 so as to rotate with regard to it. A second gear 75, a third gear 76, a sixth gear 79 and a seventh gear 80 are pivotally supported on a gear support shaft 82 mounted on a drive case 55 so as to rotate with regard to it. A rotation angle sensor 58 of the main shaft 53 and a supporting member 51 is mounted on a third deformed shaft portion 53h of the main shaft 53 on the side of the drive case 55.

Therefore, rotation of a drive motor 56 travels from a rotation pulley 70 via a first endless belt 70a and a clutch pulley 64 of an electromagnetic clutch means 57 to a first reduction pulley 71 of a reduction mechanism W, from which it travels via a second endless belt 72 to a second reduction pulley 73, further, it is transmitted via a first gear 74 to a seventh gear 80 and a drive gear 81 to a main pulley 63, from which it is transmitted via a third endless belt 69 and a drive pulley 59. The rotation drive force is transmitted via a drive shaft 52 to a supporting member 51 which is therefore rotated, so that an original cover is automatically opened/closed according to a rotation direction of the drive motor 56. In this case, a drive case 55 itself rotates together with the supporting member 51 and a lift member 54.

The remaining operation and effect are the same as those as described above with regard to embodiment 1, and thus description is omitted.

A device as above described in this embodiment 2 is slightly more complicated than that in embodiment 1, but the object of the present invention can be also achieved if implemented in this manner.

The present invention, designed as described in the foregoing, is suitable in use for automatic opening/closing devices of opening/closing members for various opened/closed members, such as office equipments in particular copying machine, printing machine and scanner.

What is claimed is:

1. An automatic opening/closing device of an opening/closing member for automatically opening and closing said opening/closing member via a hinge means with regard to an opened/closed member, wherein a drive means for this purpose mechanically independent from said opened/closed member is mounted on a side of said opening/closing member and so designed that it rotates together with said opening/closing member when said opening/closing member opens and closes.

2. The automatic opening/closing device of the opening/closing member according to claim 1, wherein said opened/closed member is a main body of an office equipment and said opening/closing member is an original cover, and said hinge means comprises at least a mounting member mounted on a side of said main body and a supporting member of said original cover mounted on said mounting member so as to rotate with regard to it, and said drive means mechanically independent from said main body is mounted on a side of said opening/closing member and so designed that it rotates together with said original cover, when said original cover opens and closes.

3. The automatic opening/closing device of the opening/closing member according to claim 2, wherein said hinge means comprises at least said mounting member mounted on said side of said main body and said supporting member of said original cover mounted on said mounting member so as to rotate with regard to it, a lift member mounted on a free end side of said supporting member so as to rotate in a direction contrary to said supporting member and a first rotation control means allowing for a rotation of said lift member, exclusively when a predetermined rotation torque is applied.

4. The automatic opening/closing device of the opening/closing member according to claim 2, wherein said hinge means comprises at least said mounting member mounted on said side of said main body and said supporting member of said original cover mounted on said mounting member so as to rotate with regard to it, said lift member mounted on said free end of said supporting member so as to rotate in a direction contrary to said supporting member and a second rotation control means urging said supporting member in an opening direction of said original cover between said mounting member and said supporting member.

5. The automatic opening/closing device of the opening/closing member according to claim 2, wherein said hinge means comprises at least said mounting member mounted on said side of said main body and said supporting member of said original cover mounted on said mounting member so as to rotate with regard to it, said lift member mounted on said free end of said supporting member so as to rotate in a direction contrary to said supporting member and a rotation restricting means allowing for said rotation of said lift member, exclusively when said predetermined rotation torque is applied.

6. The automatic opening/closing device of the opening/closing member according to claim 3, wherein said first rotation control means is a resilient means resiliently provided between a side of said mounting member and an actuating member provided at a position different from a pivotally supported position of said lift member with regard to said supporting member.

7. The automatic opening/closing device of the opening/closing member according to claim 3, wherein said first rotation control means is a resilient means resiliently provided between said lift member and said supporting member.

8. The automatic opening/closing device of the opening/closing member according to claim 4, wherein said second rotation control means is a resilient means resiliently provided between said side of said mounting member and a free end side of said supporting member.

9. The automatic opening/closing device of the opening/closing member according to claim 4, wherein said second rotation control means is a resilient means resiliently provided between said side of said mounting member and said actuating member provided at said position different from said pivotally supported position of said lift member with regard to said supporting member.

10. The automatic opening/closing device of the opening/closing member according to claim 4, wherein said second rotation control means is equipped with a fluid damper means operating at a predetermined angle of said original cover.

11. The automatic opening/closing device of the opening/closing member according to claim 5, wherein said rotation restricting means comprises said supporting member, a locking member rotatable mounted on said and said mounting member, an engagement pin mounted on a side of said lift member so as to be engaged with said locking member and a resilient means rotatably urging said locking member in one direction.

12. The automatic opening/closing device of the opening/closing member according to claim 2, wherein said drive means is mounted on said supporting member and so designed that it rotates together with said supporting member.

13. The automatic opening/closing device of the opening/closing member according to claim 2, wherein said drive means is mounted on said original cover and so designed that it rotates together with said original cover.

14. The automatic opening/closing device of the opening/closing member according to claim 1, wherein said drive means is equipped with an electromagnetic clutch means.

15. The automatic opening/closing device of the opening/closing member according to claim 1, wherein said drive means applies a rotation drive force to a hinge pin same as a drive shaft which pivotally supports said supporting member on said mounting member so as to rotate with regard to it.

16. The automatic opening/closing device of the opening/closing member according to claim 1, wherein said drive means applies a rotation drive force toward a free end side of said supporting member.

17. The automatic opening/closing device of the opening/closing member according to claim 1, wherein said drive means uses a plurality of endless belts.

18. The automatic opening/closing device of the opening/closing member according to claim 1, wherein said drive means comprises a distortion detecting means mounted on a drive shaft and a main shaft each connected with the hinge means.

19. An opened/closed member wherein it is equipped with said automatic opening/closing device according to claim 1.

20. An office equipment as a sort of opened/closed member characterized in that it is equipped with said automatic opening/closing device according to claim 1.
